(19) United States
(12) Patent Application Publication
(10) Pub. No.: US 2007/0203726 A1
(43) Pub. Date: Aug. 30, 2007

(54) STATEMENT CHECKER ASSISTANT

(75) Inventor: Ray Thompson, Bellevue, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/456,417

(22) Filed: Jul. 10, 2006

Related U.S. Application Data
(60) Provisional application No. 60/778,183, filed on Feb. 28, 2006.

(51) Int. Cl. G06Q 10/00; G06Q 30/00

(52) U.S. Cl. 705/1

(57) ABSTRACT

Methods, systems, and machine-readable media are disclosed for managing financial data associated with a plurality of financial service providers. According to one embodiment, a method of managing financial account information associated with one or more financial service providers can comprise receiving one or more selections defining a report to be generated and identifying the financial account information to be included in the report. The financial account information to be included in the report can be read from one or more data stores based on the selections. The report of the financial account information can be generated based on the selections.

### CROSS-REFERENCE TO RELATED APPLICATIONS

This application claims priority from co-pending U.S. Provisional Patent Application No. 60/778,183 filed Feb. 28, 2006 entitled “Statement Checker Assistant” which is herein incorporated by reference, as if set forth in full in this document, for all purposes.

### BACKGROUND OF THE INVENTION

Embodiments of the present invention relate generally to financial transactions. More specifically, embodiments of the present invention relate to methods and systems for managing information that is generated or accumulated in connection with financial transactions.

Databases or other collections of information of various types have grown in complexity and size. For example, financial information related to various accounts and/or transactions of one or more individuals, businesses, or other entities are commonly maintained by one or more financial institutions. This information can include, for example, accounts maintained by or related to one or more financial institutions, personal and/or transaction information related to those accounts, information for managing and/or maintaining those accounts, etc.

Furthermore, one or more financial institutions maintaining information related to a number of accounts can generate statements, reports, or other summaries of the information related to these accounts. For example, a bank can periodically generate statements related to the accounts maintained by that bank. These statements can then be provided to customers of that bank for verification and/or reconciliation.

However, as the amount of information maintained, the number of information maintaining that information and the number of accounts for which information is maintained grows, these individual statements become unwieldy. That is, an individual or other entity with multiple accounts with multiple financial institutions will receive multiple statements. These individual statements can be time consuming and burdensome for the individual to check or the financial institution to verify before sending them to the customers. Further, there is not a convenient way to integrate or combine statements from multiple financial institutions into a single report or statement. Hence, there is a need for improved methods and systems for providing statements or other reports of information from a large corpus of information maintained on behalf of a number of different entities.

### BRIEF SUMMARY OF THE INVENTION

Methods, systems, and machine-readable media are disclosed for managing financial data associated with a plurality of financial service providers. According to one embodiment, a method of managing financial account information associated with one or more financial service providers can comprise receiving one or more selections defining a report to be generated and identifying the financial account information to be included in the report. The financial account information to be included in the report can be read from one or more data stores based on the selections. The report of the financial account information can be generated based on the selections.

In some cases, prior to receiving the one or more selections, a user interface can be displayed providing options for the one or more selections. The one or more selections can include one or more indications of a source of the information, one or more indications of a location for storing the selections, one or more indications of a format for the report, as well as other settings or selections. The one or more indications of a format for the report, if any, can include, for example, a title of the report, a heading name for the report, an indication of a number of columns in the report, an indication of a column heading for each of the columns in the report, etc.

The report can be displayed based on the one or more indications of the format for the report. The report information can include, for example, client information related to each of the one or more financial service providers, customer information related to an entity for which the financial account information is maintained, and other possible information.

According to another embodiment of the present invention, a machine-readable medium can have stored thereon a series of instruction which, when executed by a processor, cause the processor to manage financial account information associated with a plurality of financial service providers by receiving one or more selections defining a report to be generated and identifying the financial account information to be included in the report. The financial account information to be included in the report can be read from one or more data stores based on the selections. The report of the financial account information can be generated based on the selections.

In some cases, prior to receiving the one or more selections, a user interface can be displayed providing options for the one or more selections. The one or more selections can include one or more indications of a source of the information, one or more indications of a location for storing the selections, one or more indications of a format for the report, as well as other settings or selections. The one or more indications of a format for the report, if any, can include, for example, a title of the report, a heading name for the report, an indication of a number of columns in the report, an indication of a column heading for each of the columns in the report, etc.

The report can be displayed based on the one or more indications of the format for the report. The report information can include, for example, client information related to each of the one or more financial service providers, customer information related to an entity for which the financial account information is maintained, and other possible information.

According to yet another embodiment, a system can comprise a communication network and a plurality of data stores communicatively coupled with the network. The data stores can be adapted to maintain financial account information associated with a plurality of financial service providers. The system can also include a client device communicatively coupled with the communication network and a server communicatively coupled with the communication network. The server can be adapted to receive from the client device one or more selections defining a report to be generated and identifying financial account information to be included in the report, read the financial account information to be included in the report from the plurality of data stores based on the selections, and generate the report of the financial account information based on the selections.

In some cases, the server can be further adapted to, prior to receiving the one or more selections, cause the client device to display a user interface providing options for the one or more selections. The one or more selections can include one or more indications of a source of the information, one or more indications of a location for storing the selections, one or more indications of a format for the report, as well as other settings or selections. The one or more indications of a format for the report, if any, can include, for example, a title of the report, a heading name for the report, an indication of a number of columns in the report, an indication of a column heading for each of the columns in the report, etc.

The server can be further adapted to cause the client device to display the report based on the one or more indications of the format for the report. The report information can include, for example, client information related to each of the one or more financial service providers, customer information related to an entity for which the financial account information is maintained, and other possible information.

### BRIEF DESCRIPTION OF THE DRAWINGS

FIG. 1 is a block diagram illustrating an exemplary environment in which embodiments of the present invention may be implemented.

FIG. 2 is a block diagram illustrating additional details of another exemplary environment in which embodiments of the present invention may be implemented.

FIG. 3 is an exemplary computer system upon which embodiments of the present invention may be implemented.

FIG. 4 is a screenshot illustrating a main window of a statement checker assistant according to one embodiment of the present invention.

FIG. 5 is a screenshot illustrating a customized report definition dialog box according to one embodiment of the present invention.

FIG. 6 is a screenshot illustrating results of a statement checker assistant according to one embodiment of the present invention.

FIG. 7 is a flowchart illustrating a process for providing statements or other reports of information according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for managing large collections of data. In some such embodiments, the processes are executed by an entity on behalf of one or more client organizations. The description below sometimes provides illustrations that use an example where a client organization is a financial institution, but there is no such requirement for the invention and the methods are intended also to be applicable to other types of organizations that make use of large collections of data. For example, embodiments of the invention may also be used for managing health-care documents or information.

The description herein sometimes refers to “clients” and to “customers.” Reference to “clients” is intended to refer to persons, i.e. individuals, entities, or their agents, on whose behalf a set of information is managed. Reference to “customers” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer.

Generally speaking, embodiments of the present invention provide tools for use in accessing a variety of financial and/or account information a large corpus of account information that may be divided among multiple database and/or systems. These tools can include, but are not limited to, a statement checker assistant. According to one embodiment of the present invention, a statement checker assistant can allow a user or users, either clients or customers, to validate various statements and calculations related to accounts maintained by one or more client entities. For example, the statement checker assistant can be used by a party, i.e., a client, maintaining the corpus of account information to verify the accuracy of that information, calculations made with that information, reports and/or statements generated from that information, etc. In another example, the statement checker assistant can be used by an individual account holder, i.e., a customer, to verify or reconcile one or more statements on one or more accounts. The statement checker may be executed periodically, on demand, either in real-time or in a batch process, etc. Furthermore, as will be discussed in detail below, reports generated by the statement checker assistant can be customized in a variety of ways to report on various accounts, possibly in various locations or databases, and to present selected information as defined by the user requesting the report.

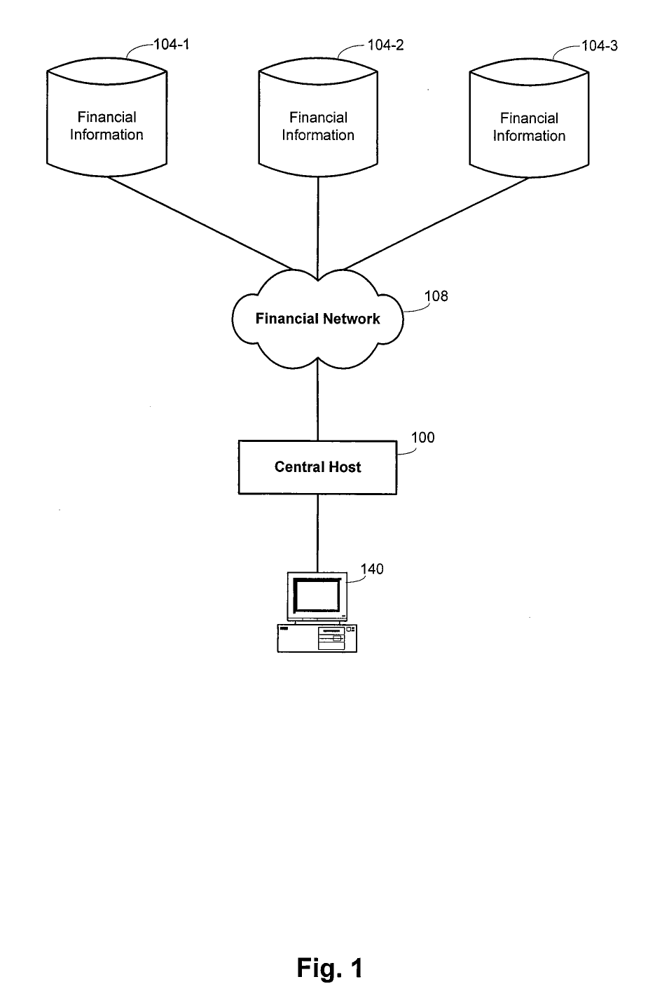

FIG. 1 is a block diagram illustrating an exemplary environment in which embodiments of the present invention may be implemented. This example illustrates a portion of an architecture into which a central host 100 can be configured to implement the methods of the statement checker. The central host may be any of a variety of general purpose personal computers including, merely by way of example, personal computers and/or laptop computers running various versions of Microsoft Corp.'s Windows, Apple Corp.'s Macintosh operating systems, any of a variety of commercially-available UNIX or UNIX-like operating systems (including without limitation, the variety of GNU/Linux operating systems), etc.

The data and/or rules received by the central host 100 may originate with one or more repositories of financial information 104 and be transmitted to the central host 100 through a financial network 108. The network may can be any type of network familiar to those skilled in the art that can support data communications using any of a variety of commercially-available protocols, including without limitation TCP/IP, SNA, IPX, AppleTalk, and the like. Merely by way of example, the network 108 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The repositories of financial information 104 may comprise information collected from or on behalf of such entities as banks, credit unions, trust-management companies, mutual fund companies, discount brokerage firms, and the like. By permitting communication with the repositories of financial information 104 through the financial network 108, the central host 100 may perform functions on behalf of a plurality of financial entities or may perform functions that report on information from multiple repositories of financial information 104 via one or more terminals 140. The terminals 140 may be any of a variety of possible types of devices including thin clients, personal computers, etc.

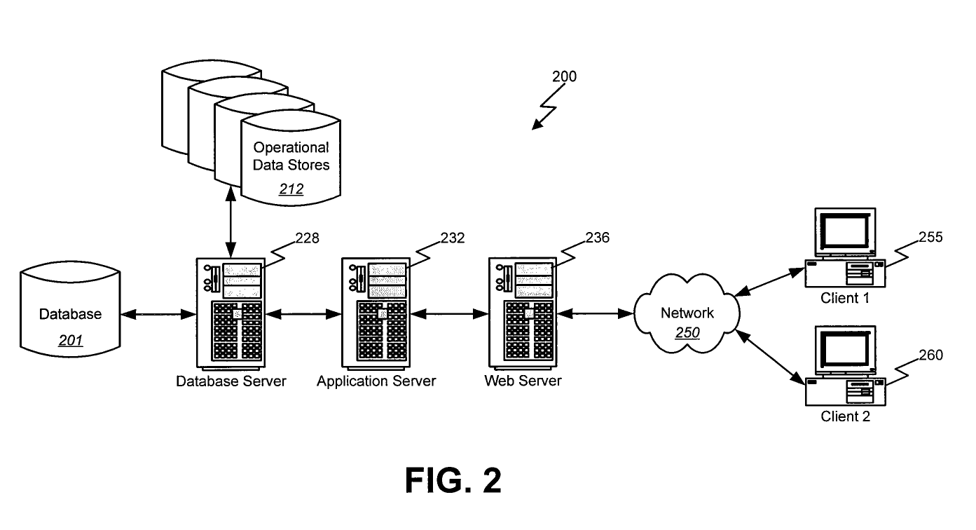

FIG. 2 is a block diagram illustrating an exemplary environment in which embodiments of the present invention may be implemented. In this example, the system 200 can include a database 201 and/or one or more operational data stores 212. The database 201 and/or operational data stores 212, like the repository of financial information 104 discussed above, may comprise information collected from or on behalf of such entities as banks, credit unions, trust-management companies, mutual fund companies, discount brokerage firms, and the like. For example, the information can include account numbers, balances, transaction records, personal records, etc. for any number of customer accounts associated with any number of financial institutions or other clients.

Generally speaking, the system 200, as illustrated in FIG. 2, provides an interface with the database 201 and/or data stores 212. Financial-service providers or other clients 255 and 260 that wish to access or perform an analysis based on the data maintained in the database 201 can interface with a web server 236 via a network 250. That is, like the central host 140 described above, the web server 236 can provide a portal through which information in the one or more operational data stores 212 can be accessed. Also as discussed above, the network 250 may can be any type of network familiar to those skilled in the art that can support data communications using any of a variety of commercially-available protocols, including without limitation TCP/IP, SNA, IPX, AppleTalk, and the like. Merely by way of example, the network 250 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The web server 236 is itself in communication with an application server 232. The application server 232 communicates with a database server 228 that performs the actual extraction of data. The application server 232 can be configured to execute functions that a user from the financial-service provider may specify through the web server 236. Importantly, while illustrated here as separate servers, the functions of the web server 236, application server 232, and database server may alternatively be implemented in any number of one or more servers.

A number of types of functions may be accessed by the clients 255 and 260 through the web server 236, application server 232 and database server 228. For example, the web server 236 may permit the clients 255 and 266 to prepare a specialized query of the database 201 in which the criteria that define what data is extracted from the database 201 are defined on a case-by-case basis by the user. In some other embodiments, a query may be selected from a menu of preformatted queries. In some embodiments, a mechanism can be provided for allowing queries to be executed on a scheduled basis, such as weekly or monthly. The specialized queries or other functions can include, but are not limited to, a statement checker assistant such as will be discussed further below.

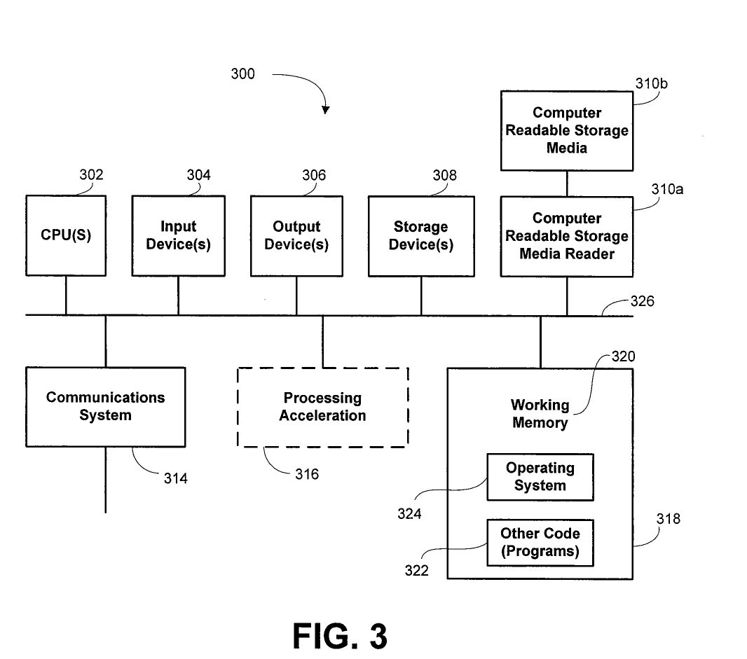

FIG. 3 is an exemplary computer system upon which embodiments of the present invention may be implemented. The computer system 300 is shown comprising hardware elements that may be electrically coupled via a bus 355. The hardware elements may include one or more central processing units (CPUs) 305; one or more input devices 310 (e.g., a scan device, a mouse, a keyboard, etc.); and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325; a communications system 330 (e.g., a modem, a network card (wireless or wired), an infra-red communication device, etc.); and working memory 340, which may include RAM and ROM devices as described above. In some embodiments, the computer system 300 may also include a processing acceleration unit 335, which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer or other type of device.

The computer system 300 may also comprise software elements, shown as being currently located within a working memory 340, including an operating system 345 and/or other code 350, such as an application program. The application programs may implement components of a strategic communications system, and/or the methods of the invention. It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

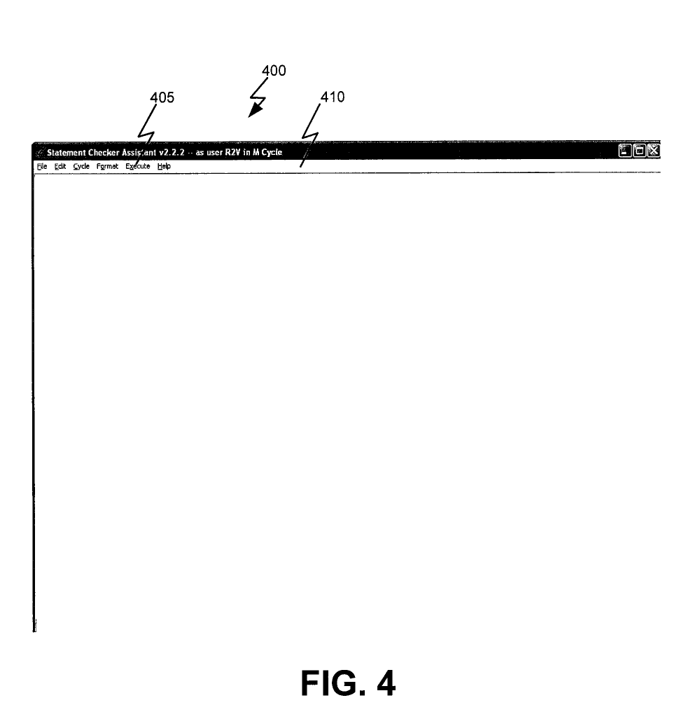

As noted above, the statement checker assistant extracts pertinent statement calculations and/or other account information from a corpus of information from one or more financial institutions or other client entities and allow the user, such as a client or customer, to validate, for example, printed statements, interest rate calculations, etc. FIG. 4 is a screenshot illustrating a main window of a statement checker assistant according to one embodiment of the present invention. This example illustrates a window 400 that can be opened or created upon initiation of the statement checker assistant. Initially, such a window 400 may be blank. That is, until a report is run, the window 400 may contain no report information for any accounts. To run a report, a user may select the “Execute” menu item 405 from the menu bar 410 at the top of the window 400. Selection of the “Execute” menu item 405 can result in a drop down submenu of other selection for selection of items such as to initiate execution now, to schedule execution, etc.

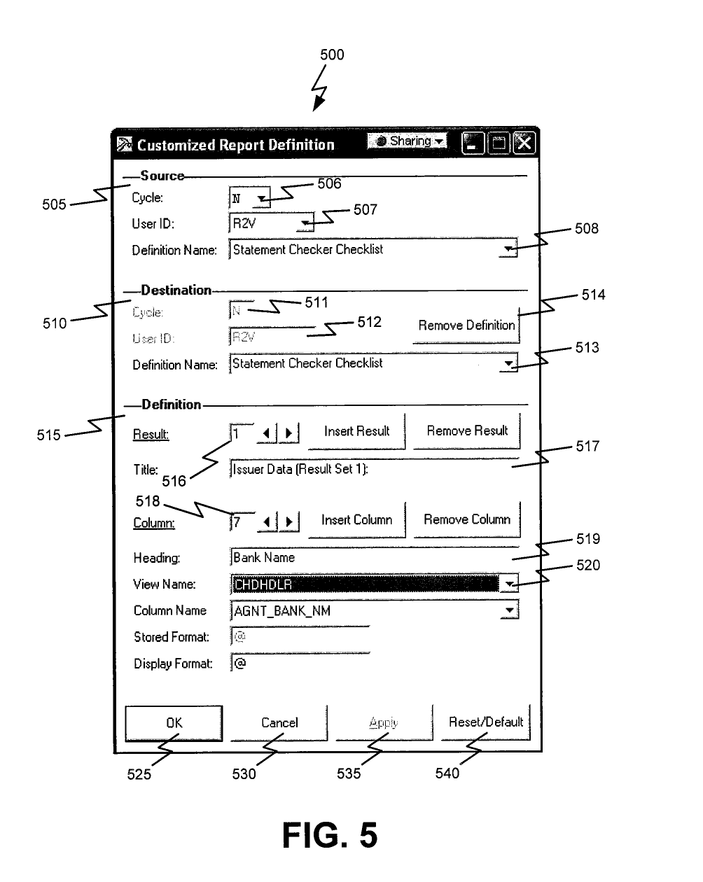

According to one embodiment of the present invention, upon initiation of report generation, i.e., in response to a user selection of the “Execute” menu selection 405 or other element of the user interface, a dialog box can be opened to allow the user to select or enter information to select, define, and/or customize the report. FIG. 5 is a screenshot illustrating a customized report definition dialog box according to one embodiment of the present invention. This dialog box 500 can include controls for customizing the data used to generate a report, the source of the data, the appearance of the report, etc. In this example, the dialog box 500 includes a source section 505 indicating a source for a report definition. This section 505 can include a number of textboxes, combo boxes, or other elements that can be used to identify a cycle 506, i.e., a set of data, or other category to serve as a source for the report. A user ID box 507 can also be provided for select a source for a base configuration for the report. That is, rather than defining a report from scratch, another report defined by another party can be used or may be selected and then modified. Furthermore, if the source party has more than one report defined, the dialog box 500 can further provide for selection between these reports based on selection of a definition name through the name box 508.

Furthermore, a destination for the report definition can be defined through the destination section 510 of the dialog box 500. That is, where the report definition will be output or saved can be defined. For example, the report definition can be saved, as originally read from the source or after being modified as will be discussed below, as a report definition for the current user. As such the user can define via boxes or other elements of the dialog box 500 a cycle 511, a user ID 512, a name 513, etc for the report definition to be used for later retrieval of the definition. The destination section 510 of the dialog box 500 can also include a “Remove Definition” button 514 to cause a selected definition to be deleted.

The dialog box 500 can also include a definition section 515 used to define a new report or modify an existing report. Through his section 515, a user can, for example, define sections 516 of the report with titles 517 for each section of the report. The user can also define columns 518 for the report and provide a heading 519 for each column. In each column, the user can further define views 520 and data to be used.

Finally, the dialog box 500 can include a number of controls 525-540, such as buttons, for accepting and/or applying changes or definitions of reports or resetting definitions. According to one embodiment of the present invention, the statement checker assistant can implement report definitions or customization as soon as they are available. That is, once the user defines a report, pressing the “Apply” button 535 can cause a currently viewed report to be updated. Additionally or alternatively, once the user defines a report, the next executed report can be based on that definition.

Therefore, the statement checker assistant provides the user with the ability to generate and/or customize reports utilizing information from a variety of diverse sources. For example, the statement checker assistant can gather information from a number of repositories of financial information, possibly from a number of different financial institutions and present a the selected information in a single report initiated through a single interface. Such a report then provides the user, controlling institution, or other entity to verify the accuracy of that information, calculations made with that information, reports and/or statements generated from that information, etc.

Upon execution of the statement checker assistant, account information for a variety of accounts from one or more financial institutions or other entities may be presented in the statement checker assistant window 600. This information can then be used to, for example, verify information, calculations, reports, statements, etc. from one or more other entities using the financial information represented in the report. For example, the statement checker assistant can be used by a party maintaining the account information, such as a client financial institution, to verify the accuracy of that information, calculations made with that information, reports and/or statements generated from that information, etc. In another example, the statement checker assistant can be used by an individual account holder, i.e., a customer of one or more client financial institutions, to verify or reconcile one or more statements on one or more accounts. The statement checker may be executed periodically, on demand, either in real-time or in a batch process, etc. Furthermore, as will be discussed in detail below, reports generated by the statement checker assistant can be customized in a variety of ways to report on various accounts, possibly in various locations or databases, and to present selected information as defined by the user requesting the report.

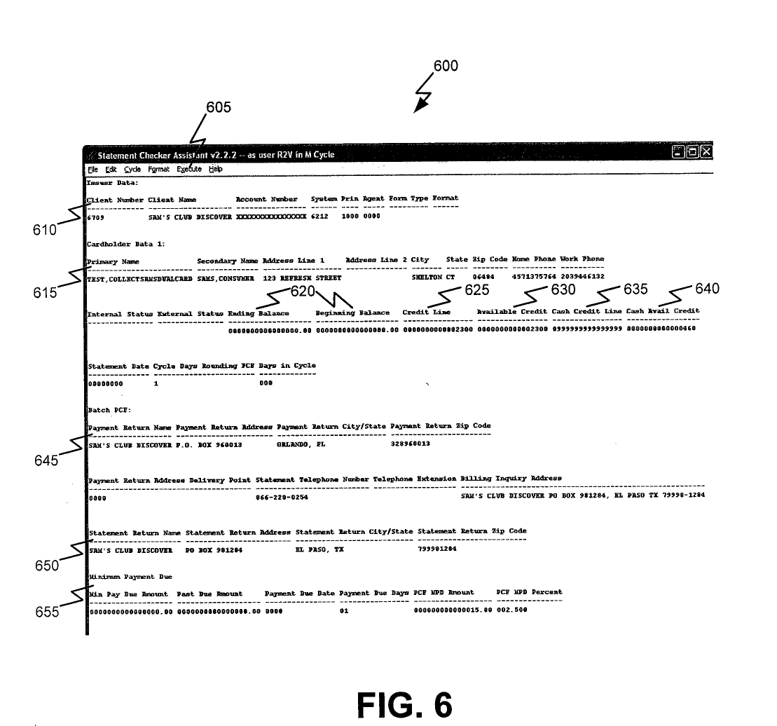

So, depending upon the configuration selected, the information displayed in the statement checker assistant window 600 can vary significantly. However, by way of example and not limitation, the window 600 illustrated in FIG. 6 includes a set of client information 610. This client information can include, but is not limited to a client number, a client name, an account number, one or more categories (i.e., a “system”, “prin” and/or “agent”) in which account information for that client is stored, etc. Also included in the statement checker assistant window 600 can be a set of customer information 615 such as a one or more names and other contact information as well as account information 620-640 such as balances 620, a credit line limit 625, an available credit limit 630, an available cash credit limit 635 etc., depending upon the type of account.

In some cases, as illustrated here, the statement checker assistant window 600 can also include payment return information 645 such as a name, address, etc. The window can additionally or alternatively include statement return information 650 such as a name, address, etc. Finally, as illustrated in FIG. 6, the window can include payment information 655 such as a minimum payment, past due amount, payment due date, etc.

It should be noted that the preceding user interfaces have been offered by way of example and not limitation. Rather, any of a variety of possible textual and/or graphical interfaces may be implemented without departing from the scope of the present invention. For example, in some cases, a purely textual interface, such as used with a terminal emulator, may be used. In other cases, various other formats, either textual, graphical, or some combination thereof may be used.

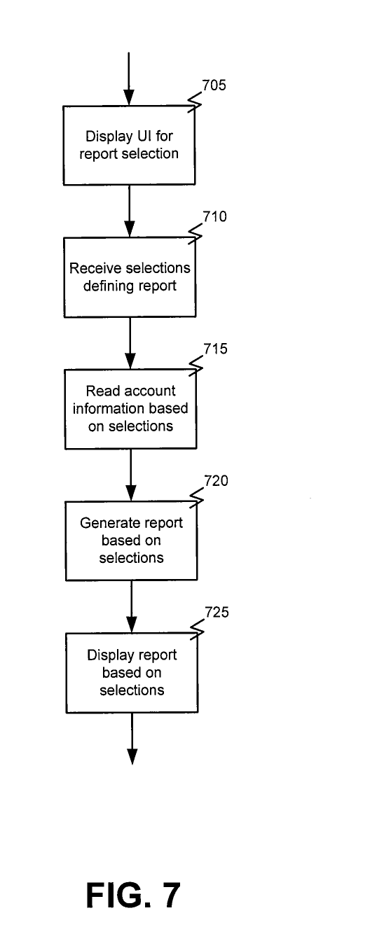

FIG. 7 is a flowchart illustrating a process for providing statements or other reports of information according to one embodiment of the present invention. In this example, processing can begin with displaying 705 a user interface such as those described above or any other interface suitable for providing options for one or more selections related to the report. The one or more selections can include, but are not limited to, one or more indications of a source of the information, one or more indications of a location for storing the selections, one or more indications of a format for the report, as well as other settings or selections. The one or more indications of a format for the report, if any, can include, but are not limited to, a title of the report, a heading name for the report, an indication of a number of columns in the report, an indication of a column heading for each of the columns in the report, etc.

The one or more selections defining a report to be generated and identifying the financial account information to be included in the report can be received 710. That is, the selections from the user interface can be passed to another process, a server, etc. The financial account information to be included in the report can be read 715 from one or more data stores based on the selections. The report of the financial account information can be generated 720 based on the selections.

The report can be displayed 725 based on the one or more indications of the format for the report. The report information can include, for example, client information related to each of the one or more financial service providers, customer information related to an entity for which the financial account information is maintained, and other possible information.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing financial account information associated with one or more financial service providers, the method comprising:
receiving one or more selections defining a report to be generated and identifying the financial account information to be included in the report;
reading the financial account information to be included in the report from one or more data stores based on the selections; and
generating the report of the financial account information based on the selections.

2. The method of claim 1, further comprising, prior to receiving the one or more selections, displaying a user interface providing options for the one or more selections.

3. The method of claim 1, wherein the one or more selections include one or more indications of a source of the information.

4. The method of claim 1, wherein the one or more selections include one or more indications of a location for storing the selections.

5. The method of claim 1, wherein the one or more selections include one or more indications of a format for the report.

6. The method of claim 5, wherein the one or more indications of a format for the report include a title of the report.

7. The method of claim 5, wherein the one or more indications of a format for the report include a heading name for the report.

8. The method of claim 5, wherein the one or more indications of a format for the report include an indication of a number of columns in the report.

9. The method of claim 8, wherein the one or more items defining a format for the report include an indication of a column heading for each of the columns in the report.

10. The method of claim 5, further comprising displaying the report based on the one or more indications of the format for the report.

11. The method of claim 1, wherein the report information includes client information related to each of the one or more financial service providers.

12. The method of claim 1, wherein the report information includes customer information related to an entity for which the financial account information is maintained.

13. A machine-readable medium having stored thereon a series of instructions that, when executed by a processor, cause the processor to manage financial account information associated with a plurality of financial service providers by:
receiving one or more selections defining a report to be generated and identifying the financial account information to be included in the report;
reading the financial account information to be included in the report from one or more data stores based on the selections; and
generating the report of the financial account information based on the selections.

14. The machine-readable medium of claim 13, further comprising, prior to receiving the one or more selections, displaying a user interface providing options for the one or more selections.

15. The machine-readable medium of claim 13, wherein the one or more selections include one or more indications of a source of the information.

16. The machine-readable medium of claim 13, wherein the one or more selections include one or more indications of a location for storing the selections.

17. The machine-readable medium of claim 13, wherein the one or more selections include one or more indications of a format for the report.

18. The machine-readable medium of claim 17, wherein the one or more indications of a format for the report include a title of the report.

19. The machine-readable medium of claim 17, wherein the one or more indications of a format for the report include a heading name for the report.

20. The machine-readable medium of claim 17, wherein the one or more indications of a format for the report include an indication of a number of columns in the report.

21. The machine-readable medium of claim 20, wherein the one or more items defining a format for the report include an indication of a column heading for each of the columns in the report.

22. The machine-readable medium of claim 17, further comprising displaying the report based on the one or more indications of the format for the report.

23. The machine-readable medium of claim 13, wherein the report information includes client information related to each of the one or more financial service providers.

24. The machine-readable medium of claim 13, wherein the report information includes customer information related to an entity for which the financial account information is maintained.

25. A system comprising:
a communication network;
a plurality of data stores communicatively coupled with the network and adapted to maintain financial account information associated with a plurality of financial service providers;
a client device communicatively coupled with the communication network; and
a server communicatively coupled with the communication network and adapted to receive from the client device one or more selections defining a report to be generated and identifying financial account information to be included in the report, read the financial account information to be included in the report from the plurality of data stores based on the selections, and generate the report of the financial account information based on the selections.

26. The system of claim 25, wherein the server is further adapted to, prior to receiving the one or more selections, cause the client device to display a user interface providing options for the one or more selections.

27. The system of claim 25, wherein the one or more selections include one or more indications of a source of the information.

28. The system of claim 25, wherein the one or more selections include one or more indications of a location for storing the selections.

29. The system of claim 25, wherein the one or more selections include one or more indications of a format for the report.

30. The system of claim 29, wherein the one or more indications of a format for the report include a title of the report.

31. The system of claim 29, wherein the one or more indications of a format for the report include a heading name for the report.

32. The system of claim 29, wherein the one or more indications of a format for the report include an indication of a number of columns in the report.

33. The system of claim 32, wherein the one or more items defining a format for the report include an indication of a column heading for each of the columns in the report.

34. The system of claim 29, wherein the server is further adapted to cause the client device to display the report based on the one or more indications of the format for the report.

35. The system of claim 25, wherein the report information includes client information related to each of the one or more financial service providers.

36. The system of claim 25, wherein the report information includes customer information related to an entity for which the financial account information is maintained.
